(19) United States
(12) Patent Application Publication
(10) Pub. No.: US 2004/0063375 A1
(43) Pub. Date: Apr. 1, 2004

(54) Glass component for television sets

(76) Inventor: Jens Pralle, Oppenheim (DE)

Correspondence Address: Pauley Petersen, Kinne & Erickson, Suite 365, 2800 West Higgins Road, Hoffman Estates, IL, 60195, US

(21) Appl. No.: 10/416,647

(22) PCT Filed: Nov. 5, 2001
(86) PCT No.: PCT/EP01/12798

(30) Foreign Application Priority Data
Nov. 14, 2000 (DE) 100 56 392.9

(51) Int. Cl. H01J 9/236

(52) U.S. Cl. 445/30

(57) ABSTRACT

A glass component for television sets. A permanent coded information can be applied during the manufacturing process of the glass component so that a non-functional surface of the glass component has binary coded information to give an information surface, whereby the coded information with “1” binary elements is presented in a multi-line and single-line or multi-digit arrangement and the “1” binary elements are arranged in the direction of molding of the component, or are applied to a partial surface so that the above are generated automatically in the form of a unitary symbol as a recess or projection on the information surface, during the imaging process from tool to the glass component. With a device, with the correspondingly selected information surface and orientation and inversion of the symbols, the coded information may be generated in the same working process as the production of the glass component.

The invention relates to a glass component for a television set, such as a display screen, picture tube cones and the like, as well as to a device for producing such a glass component.

Producers of television sets increasingly demand an extensive identification marking of the glass components in order to be able to draw conclusions regarding the production data and the like of the glass components by means of applied coded information. Often stickers provided with bar codes are used for this, however, these must be applied to the glass components in an additional work cycle.

It is also known to apply code information of this type to the glass component by means of a screen printing process, which also requires an additional work cycle, which must follow the production of the glass component.

However, the glass component can be produced by means of an injection-molding, blowing, molding and/or spinning method and the appropriate layout of the tool in a single work cycle, and can be unmolded from the tool.

It is the object of the invention to provide a glass component of the type mentioned at the outset with a permanent coded information, which does not interfere with its function and can be applied, together with the production of the glass component, in a single work cycle.

In accordance with the invention, this object is attained in that a non-functional surface of the glass component is provided with a binary coded information as the identification surface, that the code information is represented by “1” binary elements in a multi-line and single- or multi-sided arrangement, and that the “1” binary elements are aligned in the unmolding direction of the component or are applied in this way to the partial surface, which unmolds itself because of the reproduction behavior of the tool and the glass component, and are embodied as uniform symbols raised above or recessed into the identification surface.

Since the identification surface is “non-functional”, there is no interference with the function of the glass component. This can be a surface of the glass component, which is not visioble, for example. The selection of a binary coded information with “1” binary elements has the advantage that uniform symbols can be used for representing the coded information. The binary places can be distributed over one or several lines, so that a very large number of different types of information can be reproduced. Thus, with a line of 10 binary places it is possible to form 2¹⁰ items of information, while with three such lines 2³⁰ items of information can be represented.

The coded elements embodied as recessed or raised symbols can easily be cut into or placed onto the glass component by means of inverted elements of the tool. Reading devices for such symbols only need to have a capacity which is matched to the size and shape of the symbols. If these symbols are aligned in the unmolding direction of the tool, or are applied in this way to the partial surface, which unmolds itself because of the reproduction behavior of the tool and the glass component, this way of identifying the glass components does not present any difficulties during the production process, whereby the decision, by means of which method the glass component is to be produced, is left open. The spacing of the binary places in the lines is uniform, in order to be able to clearly distinguish their occupation or non-occupation with a “1” binary element and the presence of “0” binary elements.

Alphanumerical or graphic symbols can be used for the “1” binary elements. In order to be able to utilize all binary places in the lines of the coded information for forming coded information, an embodiment provides that start and end symbols, which are not used for forming the coded information, are assigned to the lines of coded information, and that these start and end symbols preferably differ from the symbols of the “1” binary elements.

Such start and end symbols make the evaluation of the coded information easier, in particular if they differ from the “1” binary elements.

In this case, the coded information can contain consecutive component numbers, additional component characteristics and production dates.

In connection with a device for producing glass components provided with such coded information, care should be taken that the identification surface in the tool is selected at a non-functional surface of the component which extends vertically in respect to the unmolding direction, or are attached in this way on a partial surface which unmolds itself because of the reproduction behavior of the tool and the glass component, and that the tool surface which determines this surface is provided with the inverse coded information.

With this alignment of the identification surface and of the symbols, the production, including the unmolding of the glass component by means of a tool, does not offer any difficulties.

In accordance with a further embodiment it is provided that at least a part of the coded information (for example the component number) changes from one produced component to the next produced component in order to identify the glass components individually. To do this it is necessary to proceed in a way that a coded information sensor is assigned to the tool, through which the coded information at the tool can be changed.

So that each binary place can be identified with a “1” or a “0”, the device provides that the coded information sensor is equipped with one embossing die per binary place with the universal “1” binary element and can be selectively brought into an active or a passive position. “0” is shown by the lack of “1”, i.e. the “1” binary element is simply missing at the respective binary place.

Examples for the formation of coded information on a flat identification surface of a glass component are represented by means of the drawings. Shown are in:

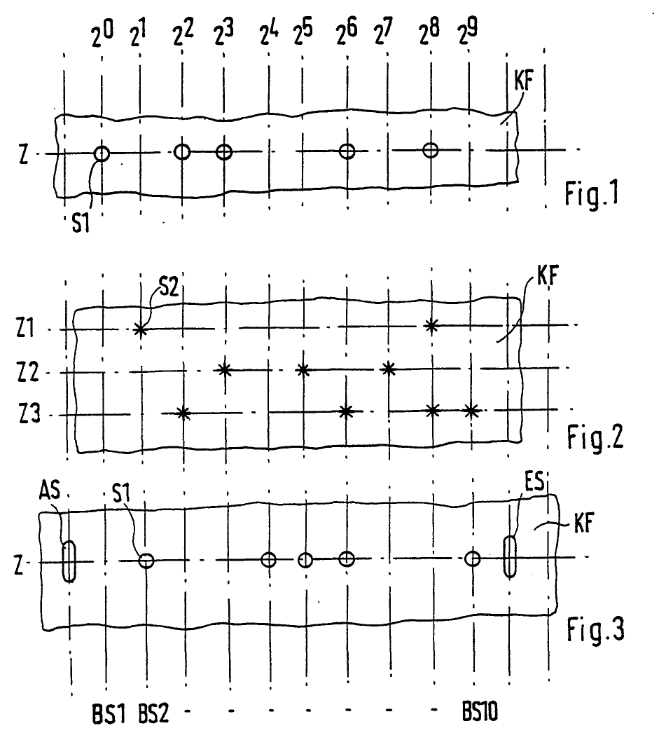

FIG. 1, a single line coded information with 10 binary places, FIG. 2, a three line coded information with 3×10=30 binary places, and FIG. 3, a single-sided coded information with 10 binary places and with a start and end symbol in a different embodiment.

With all selected exemplary embodiments, respectively 10 binary places BS1 to BS10 are provided in the lines, and values of 2⁰ to 2⁹ are assigned to them, which therefore permits the formation of 210 pieces of binary coded information per line Z, Z1 to Z3.

In the exemplary embodiment in accordance with FIG. 1, the flat identification surface KF is provided with symbols S1, which are raised in the manner of nubs or cones as the “1” binary elements, wherein the binary places BS1, BS3, BS4, BS7 and BS9 are occupied and represent the coded information 2⁰+2²+2³+2⁶+2⁸=333.

In the exemplary embodiment in accordance with FIG. 2, three lines Z1, Z2 and Z3 are provided in the identification field KF, wherein star-shaped symbols S2 have been embossed recessed into the glass component. The values of the binary places on line Z2 for the binary places BS1 to BS10 can be set from 2¹⁰ to 2¹⁹, and on line Z3 from 2₂₀ to 2₂₉, so that a total of 2³⁰ pieces of binary code information can be represented.

As shown in the exemplary embodiment of FIG. 3, in the spacing of the binary places BS1 to BS10 of a line Z, a start symbol AS is placed at the beginning and an end symbol ES at the end, which are always present and in this way unequivocally define the binary places BS1 to BS10 on the line Z, even if the binary places BS1 and BS10 are still occupied. The evaluating device can easily detect the coded information, if these symbols AS and ES differ from the symbols S1 and S2 of the “1” binary elements, for example also by their size.

When laying out the tool for producing the glass component with such an identification, care must be taken that the selected identification field KF does not have a function in the glass component and is oriented vertically in respect to the unmolding direction of the tool, or has been applied to a partial surface in this a way, which unmolds itself because of the reproduction behavior of the tool and the glass component. The images of the symbols S1, S2, AS and ES can be placed on the glass component by means of appropriately inverse counter-surfaces of the tool. If a portion of the coded information is intended to change from one produced glass component to another produced glass component, a coded information sensor is assigned to the tool, which has one embossing die with the assigned inverted symbol per binary place BS1 to BS10 of the lines Z1 to Z3, and which can be selectively brought into an active or inactive position in the tool.

1. A glass component for television sets,
characterized in that
a non-functional surface of the glass component is provided with a binary coded information as the identification surface KF),
the code information is represented by “1” binary elements in a multi-place (BS1 to BS10) and single- or multi-line (Z, Z1 to Z3) arrangement, and
the “1” binary elements are aligned in the unmolding direction of the component or are applied in this way to the partial surface, which unmolds itself because of the reproduction behavior of the tool and the glass component, and are embodied as uniform symbols raised (S1) above or recessed (S2) into the identification surface (KF).

2. The glass component in accordance with claim 1,
characterized in that
the binary places (BS1 to BS9 with the values (2⁰, 2¹, 2² . . . 2⁹) of the coded information are placed at an even spacing on the lines (Z, Z1 to Z3) of the identification surface.

3. The glass component in accordance with claim 1 or 2,
characterized in that
the “1” binary elements of the coded information are designed as alphanumerical or graphic symbols (S1, S2).

4. The glass component in accordance with one of claims 1 to 3,
characterized in that
start and end symbols (AS, ES) are assigned to the lines of coded information, which are not used for forming the coded information, and
these start and end symbols preferably differ from the symbols (S1, S2) of the “1” binary elements.

5. The glass component in accordance with one of claims 1 to 4,
characterized in that
the code information contains a consecutive component number with additional component characteristics and production dates.

6. A device for producing a glass component in accordance with one of claims 1 to 5, characterized in that
the identification surface (KF) in the tool is selected at a non-functional surface of the component which extends vertically in respect to the unmolding direction or is attached in this way on a partial surface which unmolds itself because of the reproduction behavior of the tool and the glass component, and
the tool surface which determines this surface is provided with the inverse coded information.

7. The device in accordance with claim 6,
characterized in that
at least a part of the coded information (for example the component number) changes from one produced component to the next component.

8. The device in accordance with claim 6 or 7,
characterized in that
a coded information sensor is assigned to the tool, through which the coded information at the tool can be changed.

9. The device in accordance with one of claims 6 to 8,
characterized in that
the coded information sensor is equipped with one embossing die per binary place (2⁰, 2¹, 2² . . . 2⁴) with the universal “1” binary element, which can be selectively brought into an active or a passive position.
